(19) United States
(12) Patent Application Publication
(10) Pub. No.: US 2025/0164700 A1
(43) Pub. Date: May 22, 2025

(54) END CAPS, FIBER OPTIC ADAPTERS, AND FIBER OPTIC CONNECTOR ASSEMBLIES HAVING A ROTATIONAL LOCK AND UNLOCK CONFIGURATION

(71) Applicant: CORNING RESEARCH & DEVELOPMENT CORPORATION, Corning, NY (US)

(72) Inventor: Zachary Michael Thompson, Austin, TX (US)

(21) Appl. No.: 18/915,448

(22) Filed: Oct. 15, 2024

Related U.S. Application Data
(60) Provisional application No. 63/599,699, filed on Nov. 16, 2023.

(51) Int. Cl. G02B 6/38

(52) U.S. Cl. CPC G02B 6/3825; G02B 6/3831

(57) ABSTRACT

End caps, fiber optic adapters, and fiber optic connector assemblies are disclosed. In one embodiment, an end cap is disposed within a passageway of an adapter housing includes a body, an end cap passageway within the body, and a release arm that includes a release base and a release portion extending from the release base. The release lock base extends from the body, and the release portion extends from release base in a first arcuate path within a first plane. The end cap further includes a lock arm having a lock base and a lock portion extending from the lock base, wherein the lock base extends from the body along a longitudinal axis of the end cap passageway, and the lock portion extends from the lock base in a second arcuate path within a second plane.

### PRIORITY APPLICATION

This application claims the benefit of priority of U.S. Provisional Application No. 63/599,699, filed on Nov. 16, 2023, the content of which is relied upon and incorporated herein by reference in its entirety.

### FIELD

The present disclosure is directed to fiber optic adapters and, more particularly, fiber optic adapters having a rotational lock and unlock configuration.

### BACKGROUND

Optical fiber is increasingly being used for a variety of applications, including but not limited to broadband voice, video, and data transmission. As bandwidth demands increase optical fiber is migrating deeper into communication networks such as in fiber to the premises applications such as FTTx, 5G and the like. As optical fiber extended deeper into communication networks the need for making robust optical connections in outdoor applications in a quick and easy manner was apparent.

Fiber to the premises (FTTP) is the installation of optical fiber direct to individual buildings such as single-family units, multi-dwelling units, and businesses to provide high-speed broadband access. FTTP dramatically increases connection speeds and reliability for broadband networks compared to legacy copper infrastructure.

Optical connectors are utilized to make optical connections from an optical fiber trunk to individual network subscribers. Closures such as fiber optic terminals have ports that receive fiber optic connectors of fiber optic drop cables that are run from the terminal to the individual subscribers. The ports and the fiber optic connectors are hardened and designed to withstand the outdoor conditions as they are typically deployed in a buried or aerial environment. The hardened ports and fiber optic connectors prevent moisture, dust and debris from affecting the optical connector between optical fibers of the ports and the fiber optic connectors.

The designs of ports and fiber optic connectors evolve over time, oftentimes becoming smaller and more compact in size. This leads to inoperability between newly designed fiber optic connectors and legacy port designs. For example, a smaller fiber optic connector that has a locking mechanism different from a legacy port will not mate with the legacy port.

Accordingly, a need exists for alternative fiber optic components to provide interoperability between different fiber optic connector and port configurations.

### SUMMARY

The present disclosure is directed to fiber optic adapters that enable mating between a fiber optic connector with a port for which the fiber optic connector was not designed. The fiber optic adapters described herein include a housing and an end cap that is rotationally coupled to the housing. The end cap includes locking and unlocking features that actuate a latch within the housing to lock and unlock an inserted fiber optic connector from the fiber optic adapter. The fiber optic adapters described herein are simple and use fewer parts than existing designs, while also providing strong tensile force resistance.

In one embodiment, an end cap for being rotationally disposed within a passageway of an adapter housing includes a body, an end cap passageway within the body, and a release arm that includes a release base and a release portion extending from the release base. The release lock base extends from the body along the longitudinal axis of the end cap passageway, and the release portion extends from release base in a second arcuate path within a second plane that is transverse to the longitudinal axis of the end cap passageway. The end cap further includes a lock arm having a lock base and a lock portion extending from the lock base, wherein the lock base extends from the body along a longitudinal axis of the end cap passageway, and the lock portion extends from the lock base in a first arcuate path within a first plane that is transverse to the longitudinal axis of the end cap passageway.

In another embodiment, a fiber optic adapter includes a housing having a first end and a second end, wherein a passageway is within the housing between the first end and the second end. The fiber optic adapter also includes a shuttle disposed on an inner surface of the housing within the passageway, the shuttle including a slot, and a latch having a pivot end and a latching end, wherein the latch is coupled to the shuttle such that the pivot end is disposed within the slot of the shuttle. The fiber optic adapter further includes an end cap rotationally disposed within the passageway at the second end of the housing. The end cap includes a body, an end cap passageway within the body, a release arm, and a lock arm, where the release arm and the lock arm extend from the body such that the release arm pivots the latch to a released position when the end cap is rotated in a first direction with respect to the housing, and the lock arm pivots the latch to a locked position when the end cap is rotated in a second direction with respect to the housing.

In another embodiment, a fiber optic connector assembly includes a fiber optic connector having a connector housing that includes a locking face. The fiber optic connector assembly also includes a fiber optic adapter that includes a housing having a first end and a second end, wherein a passageway is within the housing between the first end and the second end. The fiber optic adapter also includes a shuttle disposed on an inner surface of the housing within the passageway, wherein the shuttle includes a slot. The fiber optic adapter further includes a latch having a pivot end and a latching end, wherein the latch is coupled to the shuttle such that the pivot end is disposed within the slot of the shuttle. The fiber optic adapter also includes an end cap rotationally disposed within the passageway at the second end of the housing. The end cap includes a body, an end cap passageway within the body, a release arm, and a lock arm. The release arm and the lock arm extend from the body, the lock arm pivots the latch to a locked position such that the latching end of the latch is disposed between the locking face of the connector housing to lock the fiber optic connector to the fiber optic adapter when the end cap is rotated in a first direction with respect to the housing, and the release arm pivots the latch to a released position such that the latching end of the latch is removed from the locking face of the connector housing to release the fiber optic connector from the fiber optic adapter when the end cap is rotated in a second direction with respect to the housing.

Additional features and advantages will be set forth in the detailed description which follows, and in part will be readily apparent to those skilled in the art from that description or recognized by practicing the same as described herein, including the detailed description that follows, the claims, as well as the appended drawings.

It is to be understood that both the foregoing general description and the following detailed description present embodiments that are intended to provide an overview or framework for understanding the nature and character of the claims. The accompanying drawings are included to provide a further understanding of the disclosure, and are incorporated into and constitute a part of this specification. The drawings illustrate various embodiments and together with the description serve to explain the principles and operation.

### BRIEF DESCRIPTION OF THE FIGURES

FIG. 1 illustrates an exploded perspective view of an example fiber optic adapter according to one or more embodiments described and illustrated herein.

FIG. 2 illustrates a perspective view of an example fiber optic connector assembly including an example fiber optic connector and the example fiber optic adapter of FIG. 1 according to one or more embodiments described and illustrated herein.

FIG. 3 illustrates a side view of the example fiber optic adapter of FIG. 1 according to one or more embodiments described and illustrated herein.

FIG. 4 is a perspective cutaway view of the example fiber optic connector assembly of FIG. 2 according to one or more embodiments described and illustrated herein.

FIG. 5 is a top perspective view of an example end cap of a fiber optic adapter according to one or more embodiments described and illustrated herein.

FIG. 6 is a side view of the example end cap of FIG. 5 according to one or more embodiments described and illustrated herein.

FIG. 7 is another perspective view of the example end cap of FIG. 5 according to one or more embodiments described and illustrated herein.

FIG. 8 is a front view of the example end cap of FIG. 5 according to one or more embodiments described and illustrated herein.

FIG. 9 is a perspective view of a shuttle, a latch, and end cap, and a fiber optic connector inserted into the end cap in a locked state according to one or more embodiments described and illustrated herein.

FIG. 10 is a close-up perspective view of the shuttle, latch and end cap in the locked state of FIG. 9 according to one or more embodiments described and illustrated herein.

FIG. 11A is a close-up side view of the shuttle, latch and end cap in the locked state of FIG. 9 according to one or more embodiments described and illustrated herein.

FIG. 11B is a cross-sectional view of an example fiber optic connector assembly wherein the fiber optic adapter is in a locked state according to one or more embodiments described and illustrated herein.

FIG. 12 is a close-up perspective view of the shuttle, latch and end cap in an unlocked state according to one or more embodiments described and illustrated herein.

FIG. 13 is a close-up side view of the shuttle, latch and end cap in the unlocked state of FIG. 12 according to one or more embodiments described and illustrated herein.

FIG. 14A is a perspective view of an example enclosure having two example fiber optic adapters inserted into two ports according to one or more embodiments described and illustrated herein.

FIG. 14B is another perspective view of the example enclosure having two example fiber optic adapters inserted into two ports of FIG. 14A according to one or more embodiments described and illustrated herein.

### DETAILED DESCRIPTION

Reference will now be made in detail to the embodiments of the disclosure, examples of which are illustrated in the accompanying drawings. Whenever possible, like reference numbers will be used to refer to like components or parts.

Embodiments of the present disclosure are directed to adapters that enable mating between a fiber optic connector with a port for which the fiber optic connector was not designed. The fiber optic adapters described herein include a housing and an end cap that is rotationally coupled to the housing. The end cap includes locking and unlocking features that actuate a latch within the housing to lock and unlock an inserted fiber optic connector from the fiber optic adapter. The fiber optic adapter is simple and uses fewer parts than existing designs, while also providing strong tensile force resistance.

More particularly, the rotating end cap eliminates the need for external unlocking features, such as a push-button, and therefore eliminates a potential leak path and failure mode and thus reduces performance risk. Further, the designs of the fiber optic adapters described herein decouple the retention force from the user actuation force, so adjusting the retention force does not affect the user experience in any way. For example, increasing the retention force does not require a larger or different user input to release or lock the connector. The user experiences the same actuation force when turning the end cap and then pulling the fiber optic connector out of the fiber optic adapter.

Various embodiments of end caps, fiber optic adapters, and fiber optic connector assemblies are described in detail below.

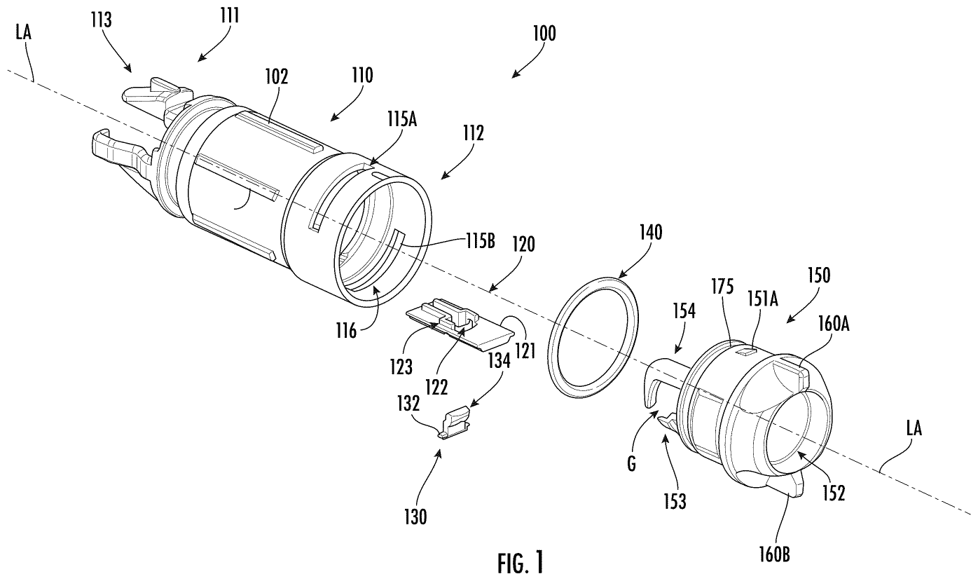

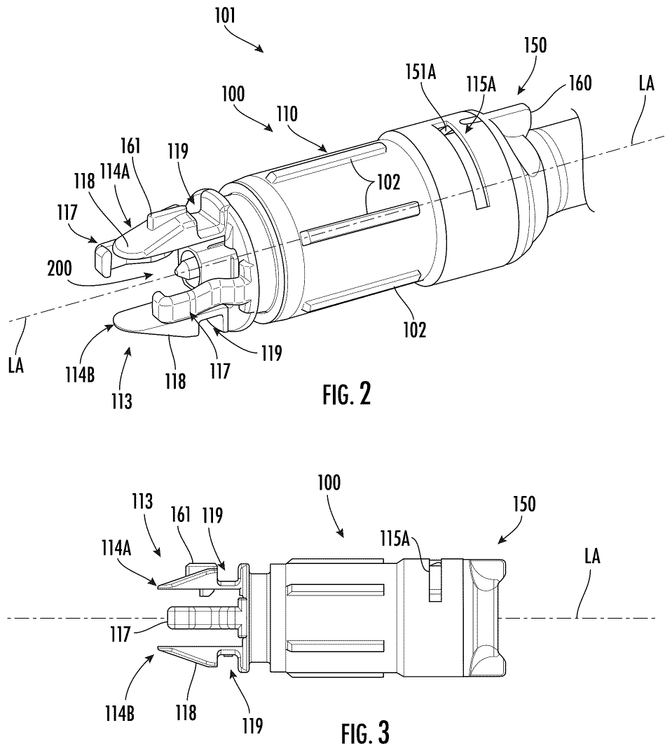

Referring now to the drawings, FIG. 1 illustrates an example fiber optic adapter 100 in an exploded view. FIG. 2 illustrates an assembled perspective view of an example fiber optic connector assembly 101 including both the fiber optic adapter 100 of FIG. 1 and a fiber optic connector 200 that is inserted into the fiber optic adapter 100. FIG. 3 illustrates a side view of the fiber optic adapter 100 of FIG. 1.

Referring generally to FIGS. 1-3, the example fiber optic adapter 100 generally includes a housing 110, a shuttle 120, a latch 130 pivotally coupled to the shuttle 120, and an end cap 150. The end cap 150 and the housing 110 define a longitudinal axis LA of the fiber optic adapter 100. The housing 110 is configured to be inserted within a port of a closure, such as a closure within a buried or aerial environment. As a non-limiting example, the housing 110 is configured to be inserted into a S9.5 port of a BPEO closure sold by Corning Optical Communications of Charlotte, NC. However, it should be understood that the housing 110 may be configured to mate with ports of other closures.

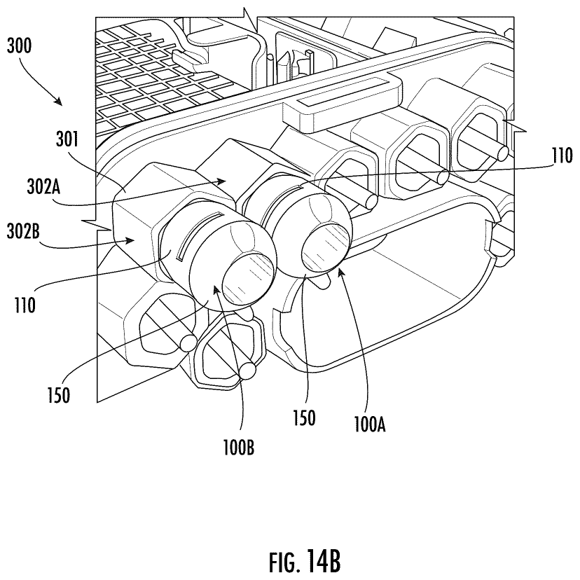

The housing 110 has a generally cylindrical shape to be inserted into a port of a closure, and has a passageway 116 for accepting the end cap 150 and a fiber optic connector 200. A plurality of securing arms 113 extend from a first end of the housing 110. At least some of the securing arms 113 define a groove 119 that accepts a wall surrounding a port of the closure (e.g., ports 302A, 302B of FIG. 14A) to prevent longitudinal movement of the fiber optic adapter 100 when it is inserted into a port. The plurality of securing arms 113 is configured to flex radially inward when the housing 110 is inserted into port due to contact with the wall surrounding the port. In the illustrated embodiment, the plurality of securing arms 113 include a first port engaging arm 114A and a second port engaging arm 114B that each have a tapered portion 118 such that a thickness of the first and second port engaging arms 114A, 114B increases in a direction along the longitudinal axis LA toward the end cap 150. The tapered portions 118 of the first and second port engaging arms 114A, 114B cause them to flex radially inward when the tapered portions 118 contact an inner surface of the wall defining the port. When the tapered portions 118 clear the inner surface of the wall, the first and second port engaging arms 114A, 114B snap back to their nominal positions such that the inner surface of the wall is disposed within the groove 119, thereby securing the housing 110 in the port. In the illustrated embodiment, the first port engaging arm 114A further includes an alignment tab 161 that is operable to be inserted into a corresponding alignment groove (not shown) of a port so that the housing 110 can be inserted into the port in only one rotational orientation.

The housing 110 may also include arms 117 that are used to hold a connector adapter (not shown) that couples the hardened connector in the port to another connector within the enclosure (not shown).

The example housing 110 further includes a plurality of radial ribs 102 that extend outward from a surface of the housing 110. The plurality of radial ribs 102 is configured to be positioned within corresponding grooves within an interior surface of the mated port to prevent rotational movement of the fiber optic adapter 100 within in the port.

The housing 110 further includes a first slot 115A and a second slot 115B at a second end that receive a first latch protrusion 151A and a second latch protrusion 151B of the end cap 150, respectively. In other embodiments, only slot and one protrusion are provided, or more than two slots and two protrusions are provided. As described in more detail below, the first and second slots 115A, 115B and first and second latch protrusions 151A, 151B prevent longitudinal movement of the end cap 150 with respect to the housing 110 along the longitudinal axis LA but allow for some rotational movement with respect to the housing 110 to lock and unlock a fiber optic connector 200 from the fiber optic adapter 100. The amount of rotational movement of the end cap 150 for locking and unlocking the fiber optic connector 200 from the fiber optic adapter 100 is limited by the length of the first and second slots 115A, 115B. Rotational movement of the end cap 150 is prevented when the first and second latch protrusions 151A, 151B reach an end of their respective first and second slots 115A, 115B.

FIG. 4 illustrates a cutaway perspective view of a fiber optic connector 200 inserted into a fiber optic adapter 100. Referring to both FIGS. 1 and 4, the shuttle 120 pivotally maintains the latch 130 used to lock the fiber optic connector 200 to the fiber optic adapter 100. The shuttle 120 is disposed within a pocket 105 of an interior surface 107. The shuttle 120 may securely fit within the pocket 105 by a snap-fit, or it may loosely fit within the pocket 105 such that it floats relative to the housing 110.

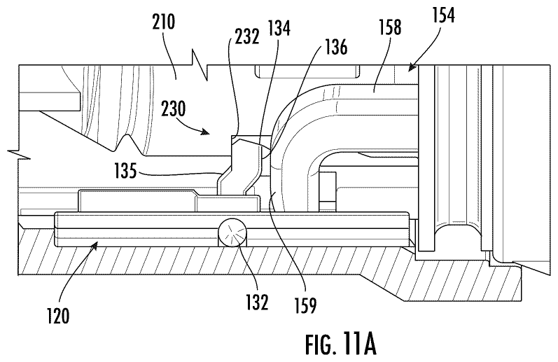

Referring briefly to FIG. 10, the shuttle 120 comprises a slot 124 that receives the latch 130. A wall 123 is adjacent the slot 124 to provide a hard stop for the latch 130 to prevent the latch from pivoting too far in a direction toward the first end of the housing 110.

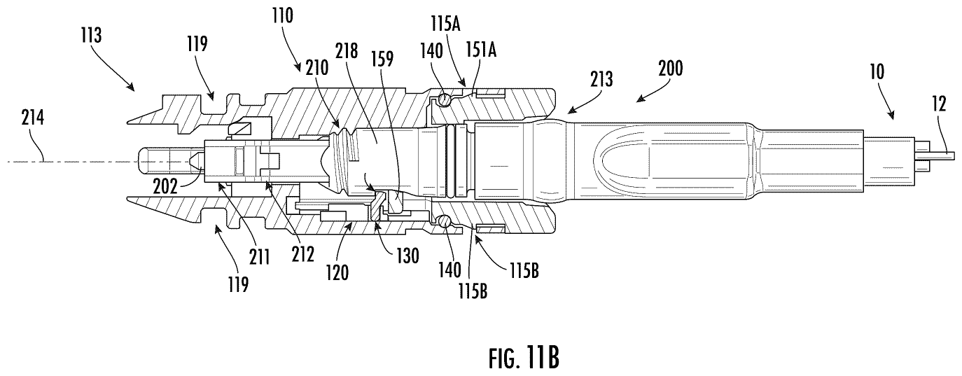

Referring once again to FIGS. 1 and 4, the latch 130 has a pivot end 132, a latching end 134, and an angled transition portion 135 between the pivot end 132 and the latching end 134. The pivot end 132 of the latch snaps into the slot 124 of the shuttle 120 so that it can pivot about an axis that is perpendicular to the longitudinal axis LA of the fiber optic adapter 100. As described in more detail below, a face of the latching end 134 contacts a locking face 232 of a connector housing 210 of the fiber optic connector 200 (see FIG. 11A) to prevent the fiber optic connector 200 from being pulled out of the fiber optic adapter 100 along the longitudinal axis LA.

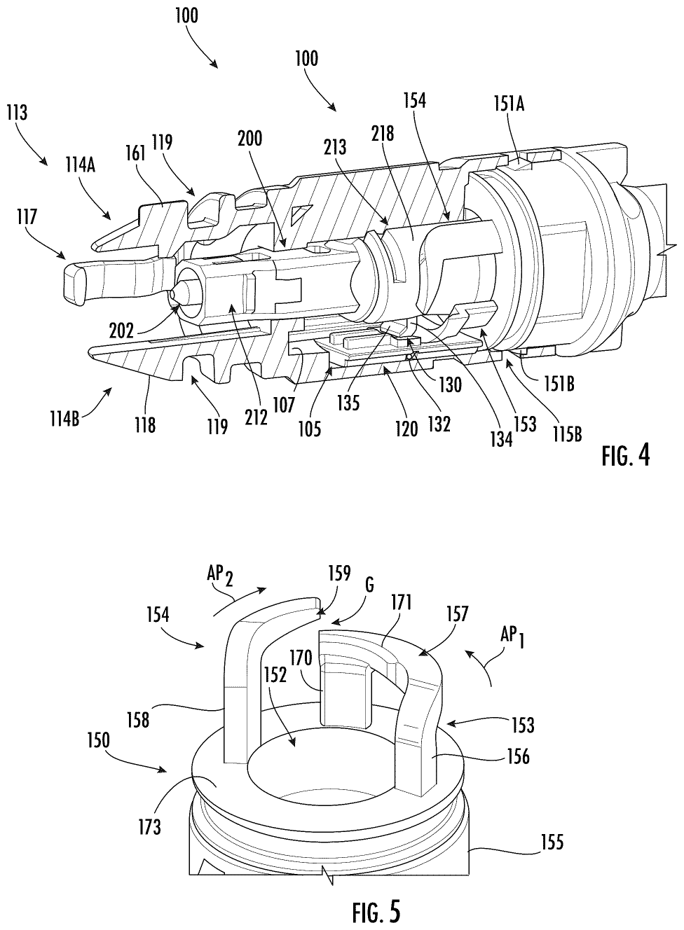

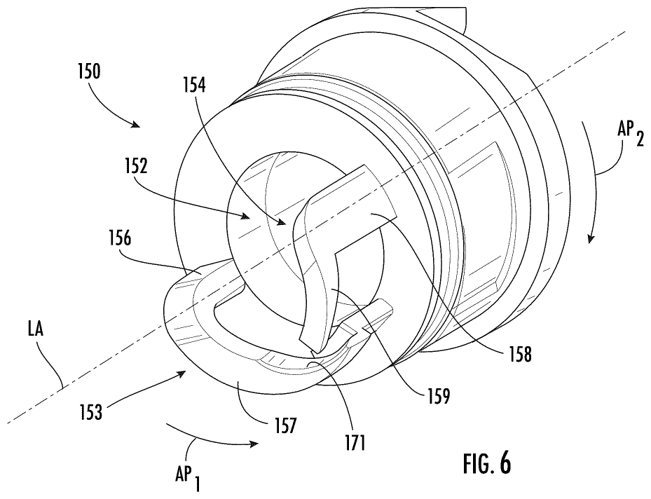

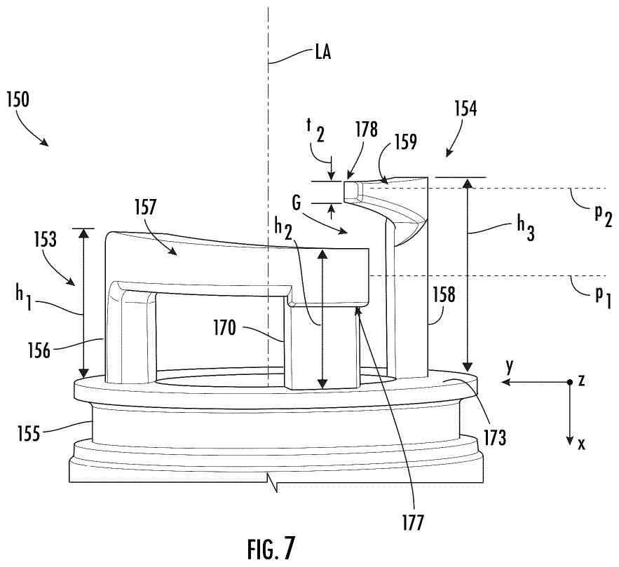

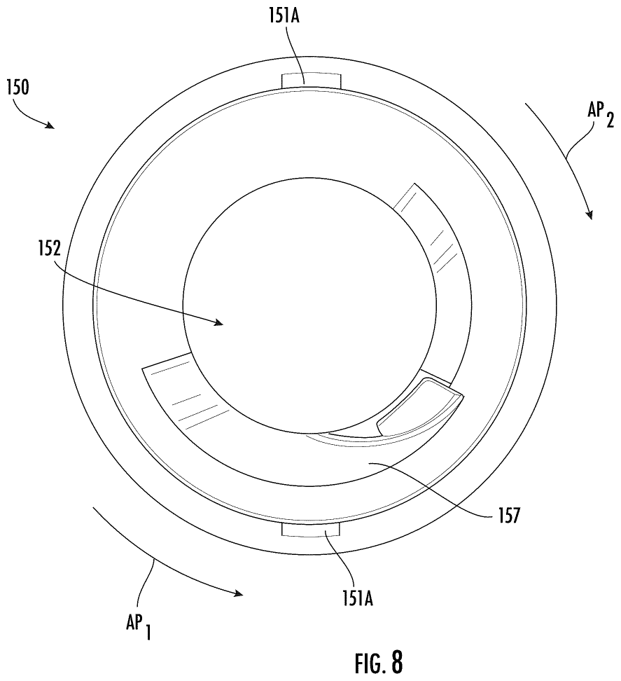

FIGS. 5 and 6 illustrate different perspective views of the example end cap 150 of FIG. 1. FIGS. 7 and 8 illustrate a side view and a front view of the example end cap 150, respectively. Referring collectively to FIGS. 5-8, the end cap 150 comprises a body 155 defining an end cap passageway 152. The end cap passageway 152 is sized to accept the fiber optic connector 200. The end cap 150 further comprises a release arm 154 and a lock arm 153 that extend from a front end of the body 155. As described in more detail below, the lock arm 153 pivots the latch 130 to a locked position such that the latching end 134 of the latch 130 is disposed between the locking face 232 of the connector housing 210 to lock the fiber optic connector 200 to the fiber optic adapter 100 when the end cap 150 is rotated in a first direction with respect to the housing 110. The release arm 253 pivots the latch 130 to a released position such that the latching end 134 of the latch 130 is removed from the locking face 232 of the connector housing 210 to release the fiber optic connector 200 from the fiber optic adapter 100 when the end cap 150 is rotated in a second direction with respect to the housing 100.

The lock arm 153 comprises a lock base 156 and a lock portion 157. The lock base 156 extends from a front face 173 of the body 151. As a non-limiting example, the lock base 156 extends from the front face 173 in a direction that is parallel to the longitudinal axis LA of the fiber optic adapter 100 defined by the end cap passageway 152. The lock base 156 extends to a first height h₁ from the front face 173 of the base (FIG. 7). The lock portion 157 extends from the lock base 156 in a first arcuate path AP₁ within a first plane P₁. Referring particularly to FIG. 7, the first plane P₁ is defined by line drawn through a midpoint of the thickness t₁ at a distal end 177 of the lock portion 157. The first plane P₁ is transverse to the longitudinal axis LA. In the illustrated embodiment the first plane P₁ is orthogonal to the longitudinal axis LA. Thus, the lock arm 153 extends from the front face 173 of the body 151 and then curves around the opening defined by the end cap passageway 152 in a first arcuate path AP₁.

In the illustrated embodiment, the lock arm 153 further comprises a support portion 170 that also extends from the front face 173 of the body 151 to a second height h₂. The second height h₂ is less than the first height h₁ such that a top surface of the lock portion 157 slopes downward toward the front face of the body 151. The support portion 170 extends between the front face 173 and the distal end 177 of the of the lock portion 157. The support portion 170 provides additional rigidity to the lock portion 157 to support the lock portion 157 when a user attempts to pull out the fiber optic connector 200 when it is locked to the fiber optic adapter 100. In other embodiments, the lock base 156 extends from the front face 173 along an entire length of the lock portion 157 to provide further rigidity. However, in other embodiments, only the lock base 156 shown in FIGS. 5-8 is provided without an additional support portion 170. In such embodiments, the lock portion 157 is free to flex in a direction parallel to the longitudinal axis LA and therefore the lock arm 153 does not contribute to tolerance stack-up with respect to the end position of the fiber optic connector 200 within the fiber optic adapter 100.

The release arm 154 comprises a release base 158 and a release portion 159. The release base 158 extends from a front face 173 of the body 151. As a non-limiting example, the release base 158 extends from the front face 173 in a direction that is parallel to the longitudinal axis LA of the fiber optic adapter 100 defined by the end cap passageway 152. The release base 158 extends to a third height h₃ from the front face 173 of the base (FIG. 7). The release portion 159 extends from the release base 158 in a second arcuate path AP₂ within a second plane P₂. Referring particularly to FIG. 7, the second plane P₂ is defined by line drawn through a midpoint of the thickness t₂ at a distal end 178 of the release portion 159. The second plane P₂ is transverse to the longitudinal axis LA. In the illustrated embodiment the second plane P₂ is orthogonal to the longitudinal axis LA and parallel to the first plane P₁. Thus, the release arm 154 extends from the front face 173 of the body 151 and then curves around the opening defined by the end cap passageway 152 in a second arcuate path AP₂ that has a direction that is opposite from the first arcuate path AP₁.

The first height h₁ of the lock base 156 is less than the third height h₃ of the release base 158 such that there is a gap G between the lock portion 157 and the release portion 159. The gap G should be large enough for the latching end 134 of the latch 130 to be positioned between the lock portion 157 and the release portion 159. The first height h₁ of the lock base 156 and the third height h₃ of the release base 158 are measured in a direction parallel to the longitudinal axis of the end cap passageway toward the front face 173 of the body 151 as shown in FIG. 8. Likewise, the gap G is measured between the lock portion 157 and the release portion 159 in a direction parallel to the longitudinal axis of the end cap passageway.

Referring once again to FIGS. 1 and 2, the end cap 150 is disposed within the passageway 116 at the second end of the housing. The first and second protrusions 151A, 151B of the end cap 150 are disposed within the first and second slots 115A, 115B of the housing 110 to secure the end cap 150 to the housing 110 such that the end cap 150 may be rotated within the passageway 116 by the user turning end cap 150, such as by using a first user activation tab 160A and/or a second user activation tab 160B at a rear of the end cap 150. The first and second user activation tabs 160A, 160B provide a location on the end cap 150 for a user to grasp and turn the end cap 150 between locked and unlocked states.

In some embodiments, the end cap 150 includes a circumferential groove 175 in which a sealing member 140, such as an O-ring, is disposed. The sealing member 140 is disposed between an inner surface of the housing 110 and the circumferential groove 175 of the end cap 150 to provide environmental sealing within the passageway 116.

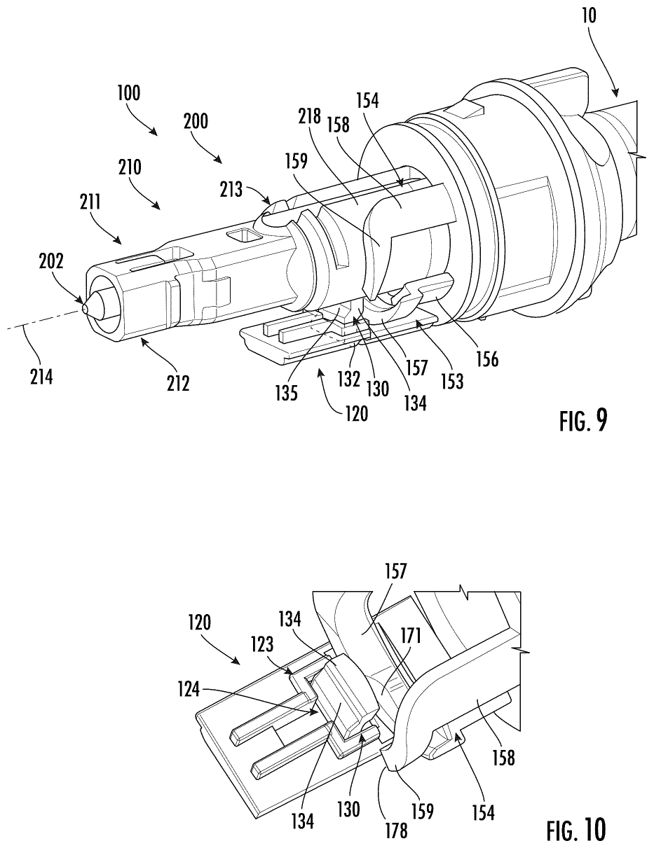

FIG. 9 illustrates a perspective view of a fiber optic connector 200 and a fiber optic adapter 100 in a locked state with the housing 110 not visible is shown. The fiber optic connector 200 generally includes a connector housing 210, including a ferrule retaining portion 212 at a front portion 211 of the connector housing 210. The connector housing 210 further includes a rear portion 213 positioned opposite the front portion 211 in an axial direction. The ferrule retaining portion 212 of the connector housing 210 is generally configured to hold and retain a ferrule 202 that is positioned at least partially within the ferrule retaining portion 212.

In embodiments, the fiber optic connector 200 is coupled to a fiber optic cable 10 at the rear portion 213 of the fiber optic connector 200 (see FIG. 11B). The fiber optic cable 10 generally includes an optical fiber 12 extending through the fiber optic cable 10. The optical fiber 12 may generally extend through the connector housing 210 and the ferrule 202 along a longitudinal axis 214 of the connector housing 210. For fiber optic cables 10 including a single optical fiber 12, the optical fiber 12 may be coaxial with the longitudinal axis 214. For multifiber cables, this alignment will be orthogonally offset for one, more than one, or all of the optical fibers of the cable.

In embodiments, the connector housing 210 generally includes an outer surface 218 that extends around a perimeter of the connector housing 210, and the outer surface 218 may include one or more cross-sectional shapes. For example, in the embodiment depicted in FIG. 2, the front portion 211 of the connector housing 210 includes a rectangular cross-section including planar sides, while the rear portion 213 of the connector housing 210 includes a curved outer surface 218.

FIG. 10 illustrates a perspective view of the shuttle 120, the latch 130 and the end cap 150 when the end cap 150 is rotated to the locked position with respect to the housing. FIG. 11A illustrates a close-up side view of the fiber optic adapter 100 and the fiber optic connector 200 when the end cap 150 is rotated to the locked position. FIG. 11B is a cross-sectional view of the fiber optic connector 200 inserted and locked to the fiber optic adapter 100.

As shown in FIG. 11A, the connector housing 210 includes a locking face 232 that extends inward from the outer surface 218 of the connector housing 210 by a distance. The locking face 232 generally defines a planar surface that is oriented transverse to the longitudinal axis of the connector. The locking face 232 is operable to contact the latching end 134 of the latch 130 when the end cap 150 is rotated to the locked position.

Referring collectively to FIGS. 9, 10, 11A and 11B, when the end cap 150 is rotated to the locked position, the lock portion 157 of the lock arm 153 makes contact with the latching end 134 of the latch 130. Because the width or thickness of the lock portion 157 increases in a direction from the distal end 177 (FIG. 7) to the lock base 156, the lock portion 157 continues to pivot the latch 130 in a direction toward the plurality of support arms 113 (FIG. 11B) until the latching end 134 of the latch 130 is disposed between the locking face 232 of the connector and the lock portion 157 of the lock arm 153. This arrangement of the latch 130 with respect to the locking face 232 and the lock portion 157 of the lock arm 153 prevents a user from pulling the fiber optic connector 200 out of the fiber optic adapter 100. Referring particularly to FIG. 10, in the illustrated embodiment the lock portion 157 has a chamfered surface 171 to ease the contact with the latching end 134 of the latch.

To unlock the fiber optic connector 200 from the fiber optic adapter 100, the user rotates the end cap 150 to the unlocked position. Referring to FIGS. 9 and 10, when the user rotates the end cap 150 to the unlocked position, the distal end 178 of the release portion 159 of the release arm 154 is rotated toward the latch 130 while the distal end 177 of the lock portion 157 of the lock arm 153 is also rotated away from the latch 130.

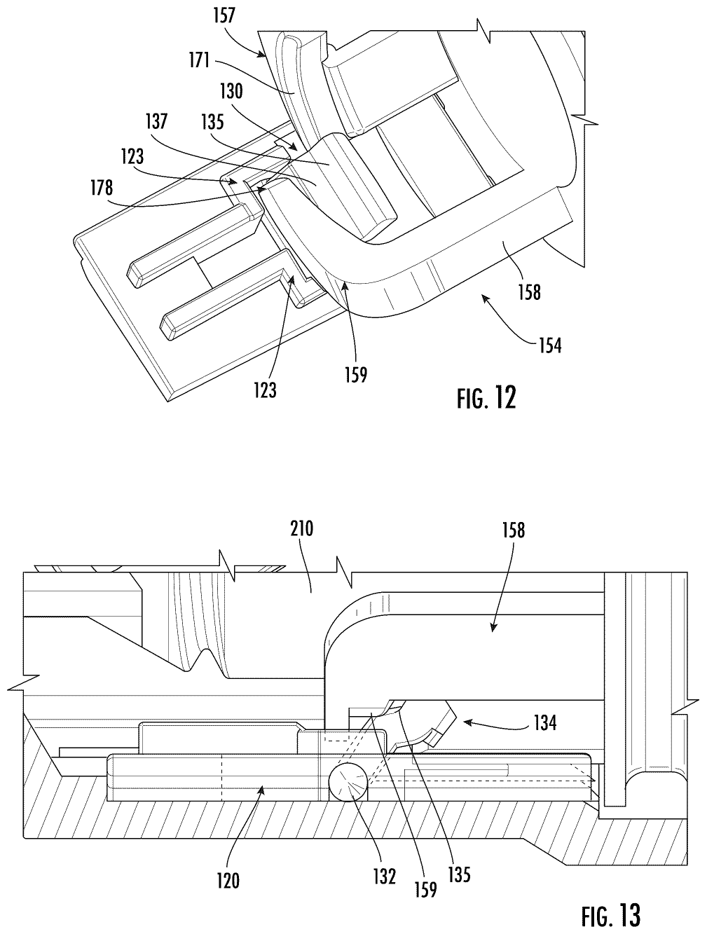

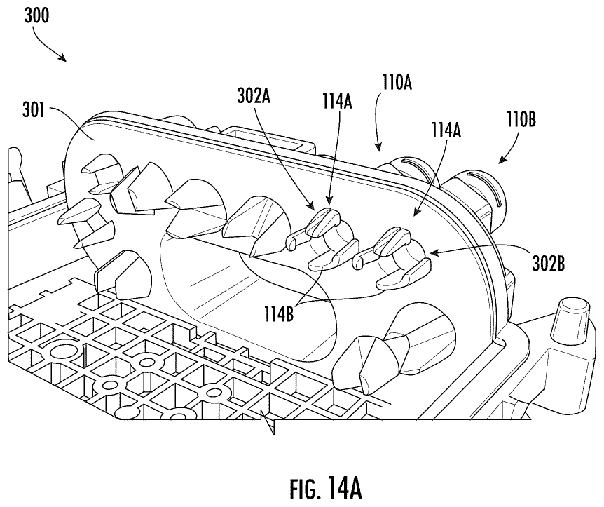

FIG. 12 illustrates the end cap 150 rotated into the unlocked position such that an inner surface of the release portion 159 contacts the transition portion 135 of the latch 130 and therefore pivots the latch in a direction toward the second end of the housing 110 that receives the end cap 150. Because the thickness of the release portion 159 increases from the distal end 178 to the release base 158, the release portion 159 gradually pivots the latch 130 to the unlocked or released position. FIG. 13 illustrates the end cap 150 in the unlocked position, and how the latch 130 is pivoted such that the latching end 134 is no longer positioned between the locking face 232 of the connector housing 210 and the lock portion 157 of the lock arm 153, and the fiber optic connector 200 can be pulled out of the fiber optic adapter 100.

Referring now to FIGS. 14A and 14B, an example closure 300 having a plurality of ports (e.g., first port 302A and second port 302B) positioned within a wall 301 is illustrated. FIG. 14A illustrates an interior perspective view of the wall 301 and FIG. 14B illustrates an exterior perspective view of the wall 301. A first fiber optic adapter 100A is inserted into the first port 302A and a second fiber optic adapter 100B is inserted into the second port 302B. The remaining ports are illustrated as unused and closed by caps. As shown in FIG. 14A, first and second port engagement arms 114A, 114B secure the first and second fiber optic adapters 100A, 100B within the first and second ports 302A, 302B, and prevent them from being pulled out of the closure 300. To insert a fiber optic connector 200 into the first or second fiber optic adapter 100A, 100B, the user rotates the end cap 150 to the unlocked position, inserts the fiber optic connector 200, and then rotates the end cap 150 to the locked position. To remove a fiber optic connector 200 from the first or second fiber optic adapter 100A, 100B, the user rotates the end cap 150 from the locked position to the unlocked position, and then pulls the fiber optic connector 200 in a direction away from the closure 300.

It should now be understood that embodiments of the present disclosure are directed to adapters that enable mating between a fiber optic connector with a port for which the fiber optic connector was not designed. The fiber optic adapters described herein include a housing and an end cap that is rotationally coupled to the housing. The end cap includes locking and unlocking features that actuate a latch within the housing to lock and unlock an inserted fiber optic connector from the fiber optic adapter. The fiber optic adapter is simple and uses fewer parts than existing designs, while also providing strong tensile force resistance.

More particularly, the rotating end cap eliminates the need for external unlocking features, such as a push-button, which therefore eliminates a potential leak path and failure mode and reduces performance risk. Further, the design decouples the retention force from the user actuation force, so adjusting the retention force does not affect the user experience in any way. For example, increasing the retention force does not require a larger or different user input to release or lock the connector. The user experiences the same actuation force when turning the end cap and then pulling the fiber optic connector out of the fiber optic adapter.

Although the disclosure has been illustrated and described herein with reference to explanatory embodiments and specific examples thereof, it will be readily apparent to those of ordinary skill in the art that other embodiments and examples can perform similar functions and/or achieve like results. All such equivalent embodiments and examples are within the spirit and scope of the disclosure and are intended to be covered by the appended claims. It will also be apparent to those skilled in the art that various modifications and variations can be made to the concepts disclosed without departing from the spirit and scope of the same. Thus, it is intended that the present application covers the modifications and variations provided they come within the scope of the appended claims and their equivalents.

1. An end cap for being rotationally disposed within a passageway of an adapter housing, the end cap comprising:
a body;
an end cap passageway within the body;
a release arm comprising a release base and a release portion extending from the release base, wherein the release base extends from the body along the longitudinal axis of the end cap passageway, and the release portion extends from release base in a first arcuate path within a first plane that is transverse to the longitudinal axis of the end cap passageway; and
a lock arm comprising a lock base and a lock portion extending from the lock base, wherein the lock base extends from the body along a longitudinal axis of the end cap passageway, and the lock portion extends from the lock base in a second arcuate path within a second plane that is transverse to the longitudinal axis of the end cap passageway.

2. The end cap of claim 1, further comprising at least one latch protrusion extending from an exterior surface of the end cap.

3. The end cap of claim 1, wherein a height of the lock base is different from a height of the release base such that a gap G is present between the lock portion and the release portion.

4. The end cap of claim 1, wherein:
a width of the lock portion becomes smaller in a direction toward a distal end of the lock portion; and
a width of the release portion becomes smaller in a direction toward a distal end of the release portion.

5. The end cap of claim 1, wherein at least one edge of the lock portion and the release portion is chamfered.

6. The end cap of claim 1, wherein an end of the end cap further comprises at least one user activation tab.

7. The end cap of claim 1, further comprising a sealing member, wherein the body of the end cap further comprises a circumferential groove, and the sealing member is disposed within the circumferential groove.

8. A fiber optic adapter comprising:
a housing having a first end and a second end, wherein a passageway is within the housing between the first end and the second end;
a shuttle disposed on an inner surface of the housing within the passageway, the shuttle comprising a slot;
a latch comprising a pivot end and a latching end, wherein the latch is coupled to the shuttle such that the pivot end is disposed within the slot of the shuttle; and
an end cap rotationally disposed within the passageway at the second end of the housing, the end cap comprising a body, an end cap passageway within the body, a release arm, and a lock arm, wherein the release arm and the lock arm extend from the body such that the release arm pivots the latch to a released position when the end cap is rotated in a first direction with respect to the housing, and the lock arm pivots the latch to a locked position when the end cap is rotated in a second direction with respect to the housing.

9. The fiber optic adapter of claim 8, wherein the housing comprises at least one slot at the second end and the end cap comprises at least one latch protrusion extending from an exterior surface of the end cap, and the at least one latch protrusion is disposed within the at least one slot.

10. The fiber optic adapter of claim 8, wherein the shuttle further comprises at least one hard stop adjacent to the slot.

11. The fiber optic adapter of claim 8, wherein:
the lock arm comprises a lock base and a lock portion extending from the lock base;
the lock base extends from the body;
the lock portion extends from lock base in a first arcuate path within a first plane that is transverse to the longitudinal axis of the end cap passageway;
the release arm comprises a release base and a release portion extending from the release base;
the release base extends from the body; and
the release portion extends from the release base in a second arcuate path within a second plane that is transverse to the longitudinal axis of the end cap passageway.

12. The fiber optic adapter of claim 11, wherein a height of the lock base is different from a height of the release base such that a gap G is present between the lock portion and the release portion.

13. The fiber optic adapter of claim 11, wherein:
a width of the lock portion becomes smaller in a direction toward a distal end of the lock portion; and
a width of the release portion becomes smaller in a direction toward a distal end of the release portion.

14. The fiber optic adapter of claim 11, wherein an edge of the lock portion contacts a first surface of the latching end of the latch to pivot the latch into the locked position when the end cap is rotated in the second direction.

15. The fiber optic adapter of claim 14, wherein the edge of the lock portion is chamfered.

16. The fiber optic adapter of claim 11, wherein an edge of the release portion contacts a second surface of the latching end to pivot the latch into the released position when the end cap is rotated in the first direction.

17. The fiber optic adapter of claim 16, wherein the edge of the released portion is chamfered.

18. The fiber optic adapter of claim 8, wherein the second end of the end cap further comprises at least one user activation tab.

19. The fiber optic adapter of claim 8, further comprising a sealing member, wherein the body of the end cap further comprises a circumferential groove, and the sealing member is disposed within the circumferential groove.

20. The fiber optic adapter of claim 8, wherein the housing comprises a plurality of radial ribs.

21. The fiber optic adapter of claim 8, wherein the first end of the housing comprises a plurality of securing arms.

22. A fiber optic connector assembly comprising:
a fiber optic connector comprising a connector housing that comprises a locking face;
a fiber optic adapter comprising:
a housing having a first end and a second end, wherein a passageway is within the housing between the first end and the second end;
a shuttle disposed on an inner surface of the housing within the passageway, the shuttle comprising a slot;
a latch comprising a pivot end and a latching end, wherein the latch is coupled to the shuttle such that the pivot end is disposed within the slot of the shuttle; and
an end cap rotationally disposed within the passageway at the second end of the housing, the end cap comprising a body, an end cap passageway within the body, a release arm, and a lock arm, wherein:
the release arm and the lock arm extend from the body;
the lock arm pivots the latch to a locked position such that the latching end of the latch is disposed between the locking face of the connector housing to lock the fiber optic connector to the fiber optic adapter when the end cap is rotated in a first direction with respect to the housing; and
the release arm pivots the latch to a released position such that the latching end of the latch is removed from the locking face of the connector housing to release the fiber optic connector from the fiber optic adapter when the end cap is rotated in a second direction with respect to the housing.

23. The fiber optic connector assembly of claim 22, wherein the housing comprises at least one slot at the second end and the end cap comprises at least one latch protrusion extending from an exterior surface of the end cap, and the at least one latch protrusion is disposed within the at least one slot.

24. The fiber optic connector assembly of claim 22, wherein the shuttle further comprises at least one hard stop adjacent to the slot.

25. The fiber optic connector assembly of claim 22, wherein:
the lock arm comprises a lock base and a lock portion extending from the lock base;
the lock base extends from the body;
the lock portion extends from lock base in a first arcuate path within a first plane that is transverse to the longitudinal axis of the end cap passageway;
the release arm comprises a release base and a release portion extending from the release base;
the release base extends from the body; and
the release portion extends from release base in a second arcuate path within a second plane that is transverse to the longitudinal axis of the end cap passageway.

26. The fiber optic connector assembly of claim 25, wherein a height of the lock base is different from a height of the release base such that a gap G is present between the lock portion and the release portion.

27. The fiber optic connector assembly of claim 25, wherein:
a width of the lock portion becomes smaller in a direction toward a distal end of the lock portion; and
a width of the release portion becomes smaller in a direction toward a distal end of the release portion.

28. The fiber optic connector assembly of claim 25, wherein an edge of the lock portion contacts a first surface of the latching end to pivot the latch into the locked position when the end cap is rotated in the first direction.

29. The fiber optic connector assembly of claim 28, wherein the edge of the locked portion is chamfered.

30. The fiber optic connector assembly of claim 25, wherein an edge of the release portion contacts a second surface of the latching end to pivot the latch into the released position when the end cap is rotated in the second direction.

31. The fiber optic connector assembly of claim 22, wherein the second end of the end cap further comprises at least one user activation tab.

32. The fiber optic connector assembly of claim 22, further comprising a sealing member, wherein the body of the end cap further comprises a circumferential groove, and the sealing member is disposed within the circumferential groove.

33. The fiber optic connector assembly of claim 22, wherein the housing comprises a plurality of radial ribs.

34. The fiber optic connector assembly of claim 22, wherein the first end of the housing comprises a plurality of securing arms.
